(19) United States
(12) Patent Application Publication
(10) Pub. No.: US 2009/0117884 A1
(43) Pub. Date: May 7, 2009

(54) Method and telephone for use of telephone book data stored in a telephone book data bank of a server

(75) Inventor: Volker Mosker, Isselburg (DE)

Correspondence Address: STAAS & HALSEY LLP, SUITE 700, 1201 NEW YORK AVENUE, N.W., WASHINGTON, DC, 20005, US

(73) Assignee: Siemens Home and Office Communication Devices GmbH & Co. KG, Munich (DE)

(21) Appl. No.: 11/920,976

(22) PCT Filed: Mar. 8, 2007
(86) PCT No.: PCT/EP2007/052188

§ 371 Date: Nov. 23, 2007

(30) Foreign Application Priority Data
Mar. 8, 2006 (EP) 06004747.9

(51) Int. Cl. H04L 29/06; H04M 3/42; G06F 17/30

(52) U.S. Cl. 455/414.3; 379/218.01; 707/E17.014; 707/3

(57) ABSTRACT

By storing part of a telephone book request in a telephone, telephone book data stored in a telephone book data bank in a server may be used by a telephone for telephone applications. A direct telephone book search in the telephone data bank of the server by a dedicated protocol is initiated by the telephone by transmission of search criteria. The telephone receives in exchange the search results and can understand the semantics of the search results based on markings in the dedicated protocol, such that the data of the search result can be used directly for telephone-specific operations. For example, outgoing telephone calls, storage in a local telephone book and determination of call number information on incoming telephone calls may be performed at the telephone using the search results.

### CROSS REFERENCE TO RELATED APPLICATIONS

This application is based on and hereby claims priority to European Application No. 06004747.9 filed on Mar. 8, 2006, the contents of which are hereby incorporated by reference.

### BACKGROUND

According to the related art, the use of telephone book data stored in a telephone book data bank of a server by a telephone or the realization of a regular and/or inverse telephone book search in the public/external telephone book is based on web-based mechanisms such as WAP or HTML pages (Wireless Application Protocol; Hyper-Text Markup Language) for example.

When reference is made to a telephone book data bank in the text below, then the content of this data bank includes not only a telephone directory (telephone book), but rather can also include any type and form of communication directory, e.g. a trade directory. A regular telephone book search is understood to mean the search for other information/data stored in the data bank for a known telephone number or call number. Conversely, an inverse search is the search for the telephone/call number associated with the stored information/data. The telephone/call number with the corresponding information/data forms one data record in the telephone book data bank; there are a plurality of such data records depending on the size of the data bank. The information/data forming the data record in each case together with the telephone/call number of a subscriber includes, in the case of a telephone directory for example, the name (e.g. first and last name), the place of residence, the street, the state/country, the zip code, the fax number, the email address etc. of the subscriber, while in the case of a trade directory the information/data further includes the category in the trade directory.

FIG. 1 shows with reference to a message sequence chart the principle of how a web-based telephone book search is carried out according to the related art. A terminal/telephone TE, for instance one with a user interface BSS that includes a browser and a keypad for example, is connected to a server SE and via this connection has access to a telephone book data bank TBD assigned to the server SE. The terminal TE is for example a personal computer with an HTTP/HTML-based (Hyper-Text Transfer Protocol; Hyper-Text Markup Language) internet browser (web browser), while the telephone is a WAP-enabled mobile telephone for example. So that the terminal/telephone TE, depending on the design, can access telephone book data stored in the telephone book data bank TBD—for example during a telephone book search—an “HTTP/WAP” protocol HW-PK is used between the terminal/telephone TE and the server SE for the accesses. According to the protocol HW-PK, with a first message M1 the terminal/telephone TE requests a search page from the server SE. With a second message M2, the requested search page is then transmitted by the server SE to the user interface BSS of the terminal/telephone TE. Following this, via the user interface BSS, search criteria are entered by the user of the terminal/telephone TE on the search page obtained from the server SE. Following this input, the search page with the search criteria is sent with a third message M3 from the terminal/telephone TE to the server SE. As soon as the server SE has acquired the search criteria transmitted with the search page, using a fourth message M4 to the telephone book data bank TBD it initiates reading out of the data matching the search criteria for a search result from the telephone book data bank TBD. With a fifth message M5, the data found for the search result is transmitted from the telephone book data bank TBD to the server SE. The server SE then assembles the data obtained in a search result in the “HTML/WAP” format and sends the search result in a sixth message M6 to the terminal/telephone TE, where the transmitted search results cannot be automatically further processed.

Further information on this related art is available on the internet, for example, at the following links:

www.slacky.de/docs/projects/isdnmonitor.html (use of the inverse search with Deutsche Telekom for Linux-based ISDN call monitoring based on the T-Com web page).
www.iir.at/pdfs/award2004 gewinner.pdf (3G telephone book for UMTS devices based on the SuperPages from Hutchison 3G Austria GmbH).
www.linuxforen.de/forums/showthread.php?t=189361 (script for using the inverse search of T-Com for the Linux VBOX answering machine, likewise based on the T-Com web page).

### SUMMARY

An aspect is to disclose a method and a telephone for use of telephone book data stored in a telephone book data bank of a server, with which the telephone book data is used in the telephone for telephony applications.

The underlying idea is to shift part of the telephone book query into the telephone and to initiate from the telephone a direct telephone book search in a telephone book data bank of a server by a dedicated protocol by transmitting search criteria (“embedded system” principle). In exchange the telephone receives the search results and can understand the semantics of the search results on the basis of tags in the dedicated protocol, so that it can directly use the data of the search results for telephone-specific operations, for example outgoing telephone calls, storing in a local telephone book, resolving call number information (CLIP information; Calling Line Identification Presentation) for incoming telephone calls. The results of the search are therefore further used or further processed immediately. It is thus possible for example to directly dial a call number found or to store it locally in a telephone book memory of the telephone. In addition, an incoming telephone call with calling line identification presentation (call with CLIP) can be directly assigned a name and possibly an address if the transmitted call number is not contained in the local telephone book memory.

The essence of the method described below is the use of the dedicated protocol for signaling instead of a web interface and its implementation in a telephone. Such a protocol is preferably defined together with a service provider for telephone book searches. Such a protocol may also be standardized.

The dedicated protocol is preferably designed for small proprietary “embedded systems” and may be both tailored to a service provider as well as proprietary. In addition, in principle the technical concept may also be utilized for other services.

In principle two embodiments may be realized for the above-mentioned protocol:
a) Realization of the service using a transmission method (FSK modulation; Frequency Shift Keying) also used for CLIP (Calling Line Identification Presentation) and a protocol to be defined. That is to say, instead of or in addition to the telephone number, the name and/or the address of the caller is transmitted to the telephone. Alternatively, a selective search would also be possible using this method, provided that a back channel is realized. The user is displayed for example a CLIP number that he does not know and can then initiate the inverse telephone book search. Searching for a telephone number on the basis of a name and an address can also be realized in this way.
b) Realization by an IP-based (Internet Protocol) protocol on telephones that have access to the internet. Communication with a telephone book data bank on the internet is realized by a dedicated protocol. For example simple “XML/HTML clear text”-based (EXtended Markup Language; HyperText Markup Language) data communication (in principle pure data bank queries) can be performed here in the manner of a client/server-based concept to enable the above-described scenarios (number search on basis of name/address, inverse search on basis of telephone number) for the telephone user.

It should be noted with respect to both approaches that different business models may be used:

free use of the service,

chargeable use of the service as “pay per use” or as a monthly flat fee.

The main application area is telephones, for example Digital Enhanced Cordless Telecommunications (DECT), WLAN, Bluetooth, GSM, UMTS telephones, telephones with an ETHERNET connection etc., which are connected to a packet-switched network, for example the internet, and/or to a circuit-switched network, for example public switched telephone network (PSTN), integrated services digital network (ISDN), using “digital subscriber line (DSL)” technologies.

### BRIEF DESCRIPTION OF THE DRAWINGS

These and other aspects and advantages will become more apparent and more readily appreciated from the following description of the exemplary embodiment, taken in conjunction with the accompanying drawings of which:

FIG. 1 is a message sequence chart for illustrating the principle of how a web-based telephone book search is carried out according to the related art;

FIG. 2, formed of FIGS. 2A and 2B, is a message sequence chart for illustrating the basic telephone book search;

FIG. 3, formed of FIGS. 3A and 3B, is a message sequence chart for illustrating an inverse telephone book search based on CLIP information;

FIG. 4, formed of FIGS. 4A and 4B, is a message sequence chart for illustrating an inverse/regular telephone book search based on a manual input.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

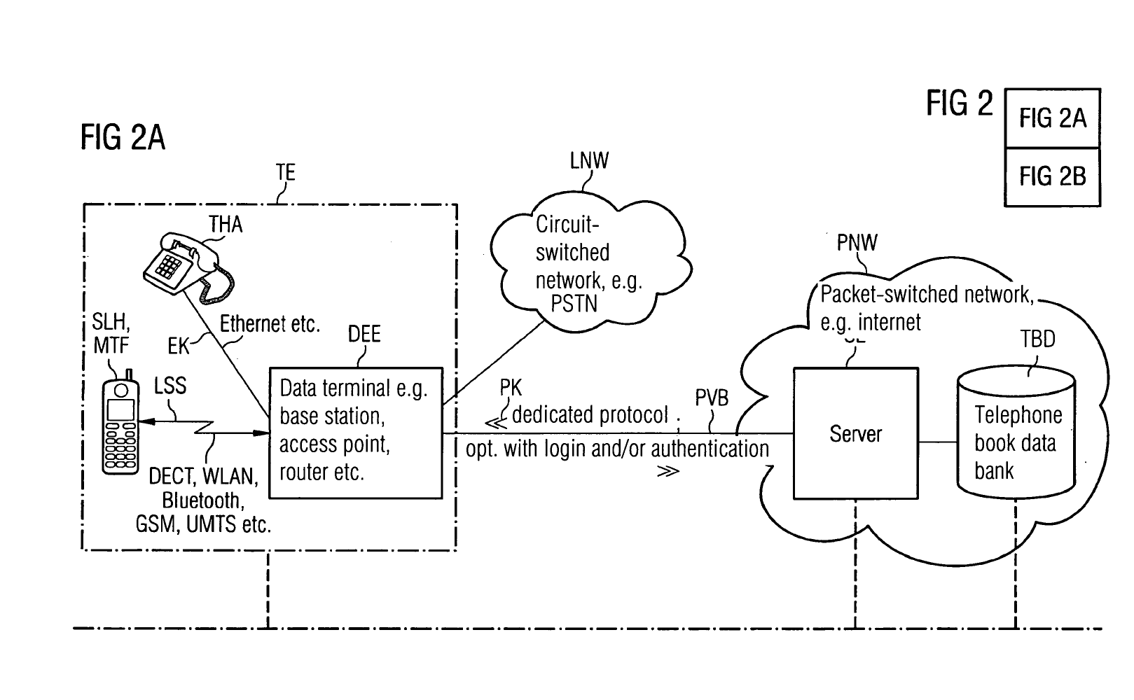

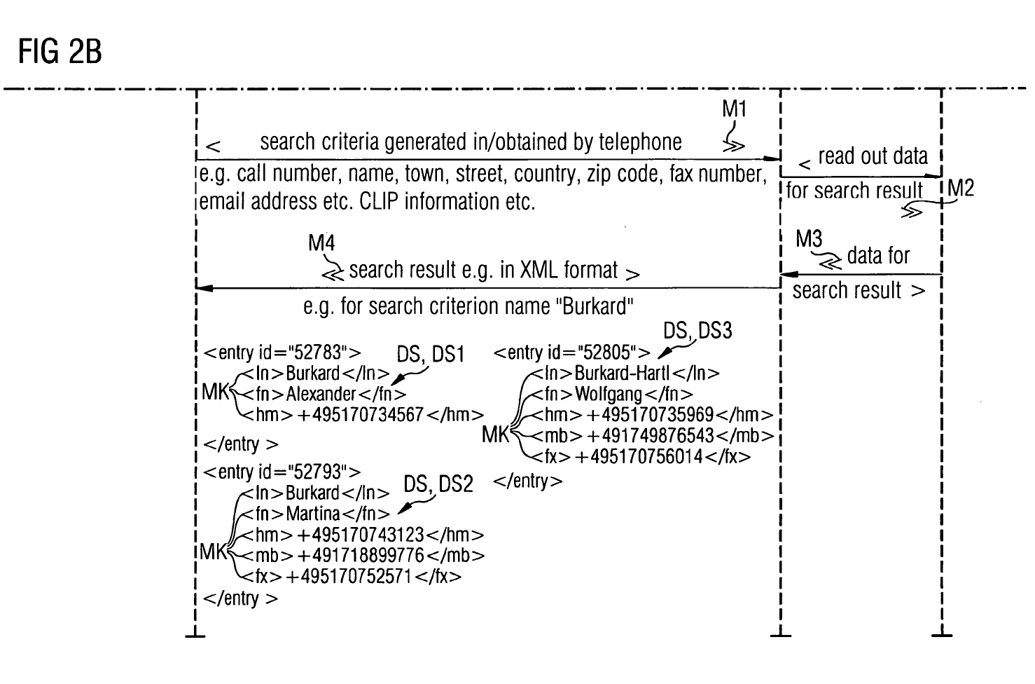

FIG. 2 shows with reference to a message sequence chart how the telephone book search is carried out in principle. A telephone TE used for the telephone book search includes for example a data transmission device DEE which is connected via an ETHERNET cable EK to a telephone handset THA, or via a “DECT/WLAN/Bluetooth/GSM/UMTS” air interface LSS to a cordless handset SLH adapted to the “DECT/WLAN/Bluetooth” air interface LSS, or to a mobile telephone MTF adapted to the “GSM/UMTS” air interface LSS. The telephone handset THA is for example an analog telephone set, the cordless handset SLA is for example a DECT mobile unit or a WLAN mobile unit, and the data terminal DEE is for example a router in the case of the telephone handset THA, is a cordless handset SLH, for example a DECT base station, in the case of the DECT mobile unit, and is a cordless handset SLH, for example a WLAN access point, in the case of the WLAN mobile unit.

The respective telephone TE designed in such a way is connected via the data terminal DEE and via a physical connection PVB to a server SE, and has access via the connection PVB to a telephone book data bank TBD assigned to the server SE. In addition, the telephone TE is physically connected via the data terminal DEE to a circuit-switched network LNW, which is the Public Switched Telephone Network (PSTN) for example. The server SE and the telephone book data bank TBD are assigned to a packet-switched network PNW, which is the internet for example.

So that the telephone TE, depending on the design, can access telephone book data stored in the telephone book data bank TBD—for example during a telephone book search—a dedicated protocol PK is used between the telephone TE and the server SE for the accesses; the telephone TE and the server SE communicate with one another according to the protocol. A login and/or authentication is provided as an optional feature of the protocol PK. This means that, when it wishes to access the server SE or telephone book data bank TBD respectively, as part of a telephone book search for example, the telephone TE must first log in to the server SE or the telephone book data bank TBD and/or be authenticated.

According to the dedicated protocol PK, with a first message M1 the telephone TE transmits to the server SE search criteria generated in the telephone TE and/or obtained by the telephone. In the case of an inverse telephone book search, the search criteria generated in the telephone are for example the respective call number of a subscriber to be searched for, and in the case of a regular search the name, the town, the street, the country, the zip code, the fax number and/or the email address for example. The search criterion obtained by the telephone is for example CLIP information transmitted to the telephone. After the search criteria have been transmitted, using a second message M2 to the telephone book data bank TBD the server SE initiates reading out of the data matching the search criteria for a search result from the telephone book data bank TBD. With a third message M3, the data found for the search result is transmitted from the telephone book data bank TBD to the server SE. The server SE then assembles the data obtained in a search result in the “XML” format for example and sends the search result to the telephone TE in a fourth message M4.

FIG. 2 shows a possible search result resulting from entering the name “Burkard” as search criterion (regular telephone book search). The search result transmitted to the telephone TE includes for example three data records DS found in the telephone book data bank TBD, a first data record DSI, a second data record DS2 and a third data record DS3, which are preferably transmitted sequentially. The sequential method of transmission is particularly suitable for transmitting a relatively large volume of data. Each of the data records DS has a data record structure characterized by tags MK of the dedicated protocol PK which enables the telephone TE that receives the data records to understand the semantics of the search result (of the data records) and to use the individual data items in the respective data record independently of one another for telephone-specific operations [for example outgoing telephone calls, storing in a local telephone book, resolving call number information (CLIP information; Calling Line Identification Presentation)].

### Example

On the basis of the “<hm>” tag MK which indicates a fixed network home number, once it has received the search result the telephone TE can, immediately or following selection/confirmation by the telephone user, initiate a telephone call to the subscriber having the fixed network home number.

The other tags used “<In>”, “<fn>”, “<mb>”, “<fx>” MK indicate the following respectively: last name, first name, mobile phone number, fax number. There are also corresponding tags depending on the total number of data types used (e.g. name, town, street, country, zip code, fax number, email address etc.) in the telephone book data bank and in the telephone book search. The search result preferably contains a complete data record DS stored in the telephone book data bank TBD for the search criterion, or respectively each individual data record for all the data stored in the telephone book data bank TBD for the search criterion. It is however also possible to transmit only part of the data or an incomplete data record.

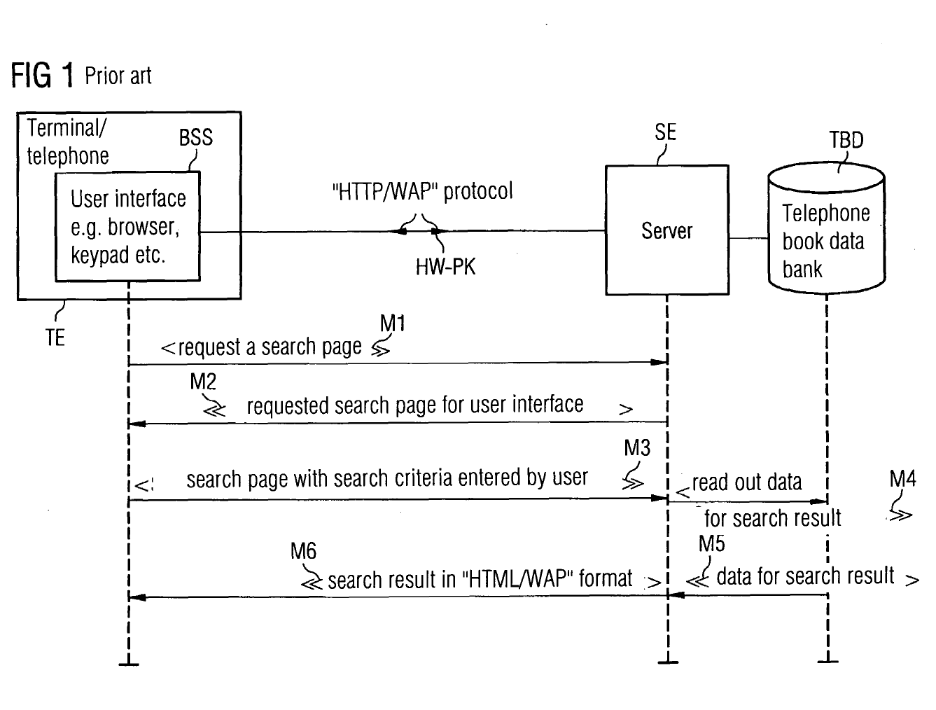

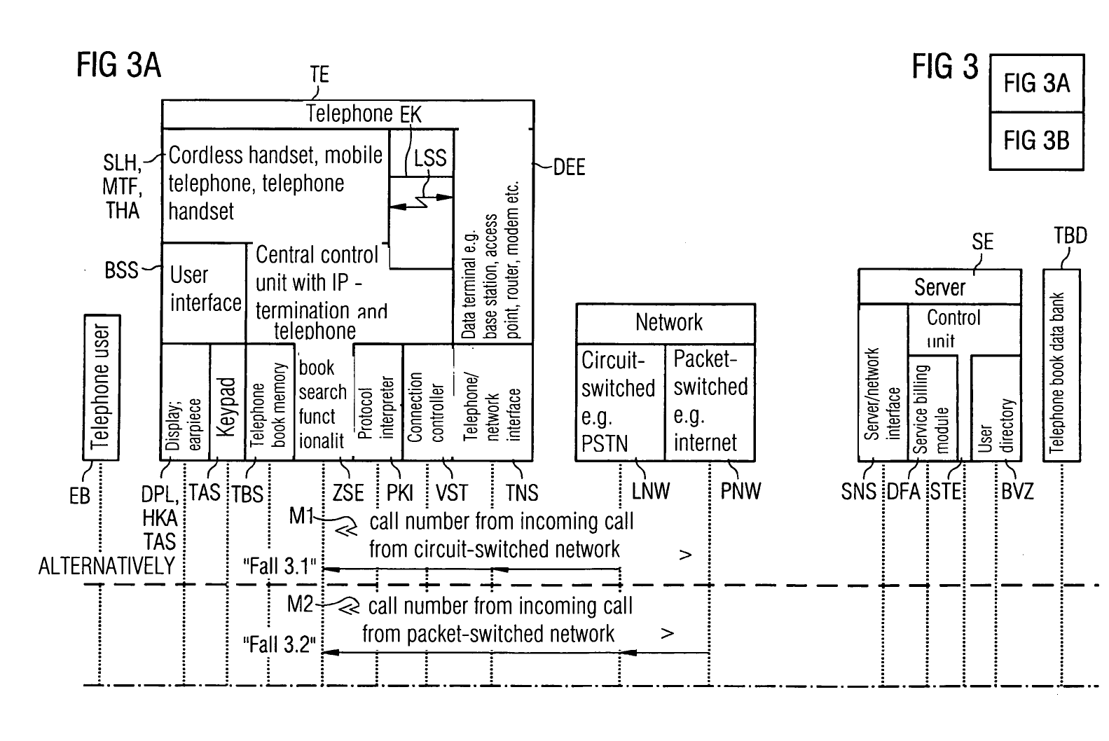

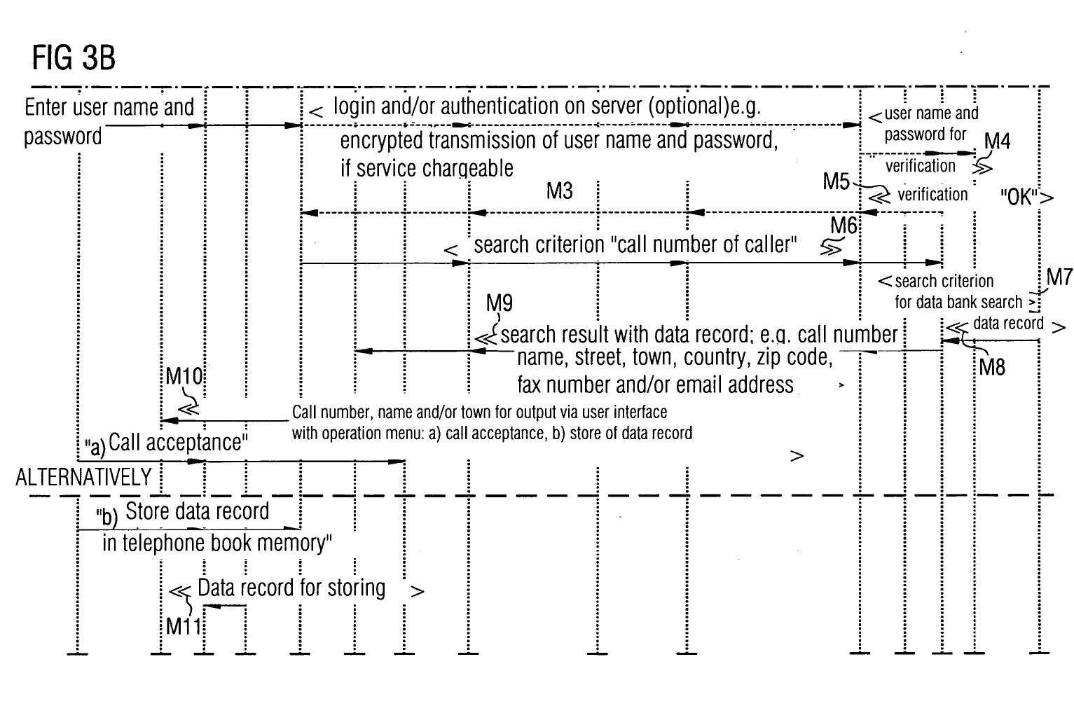

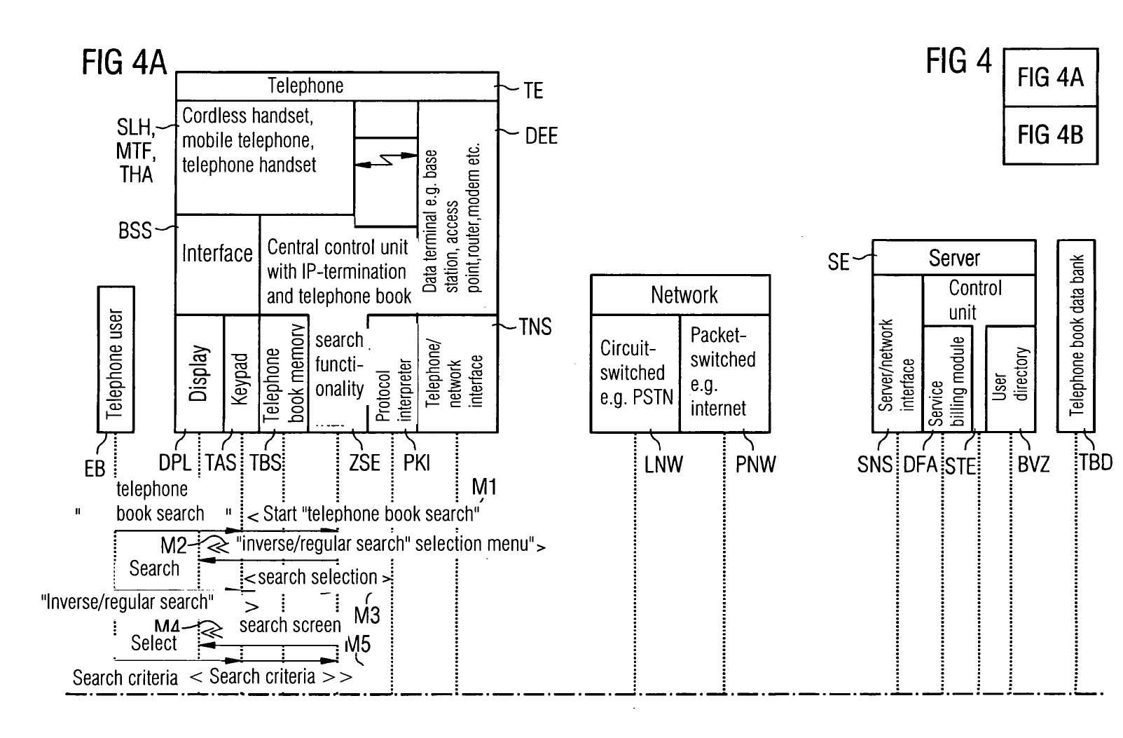

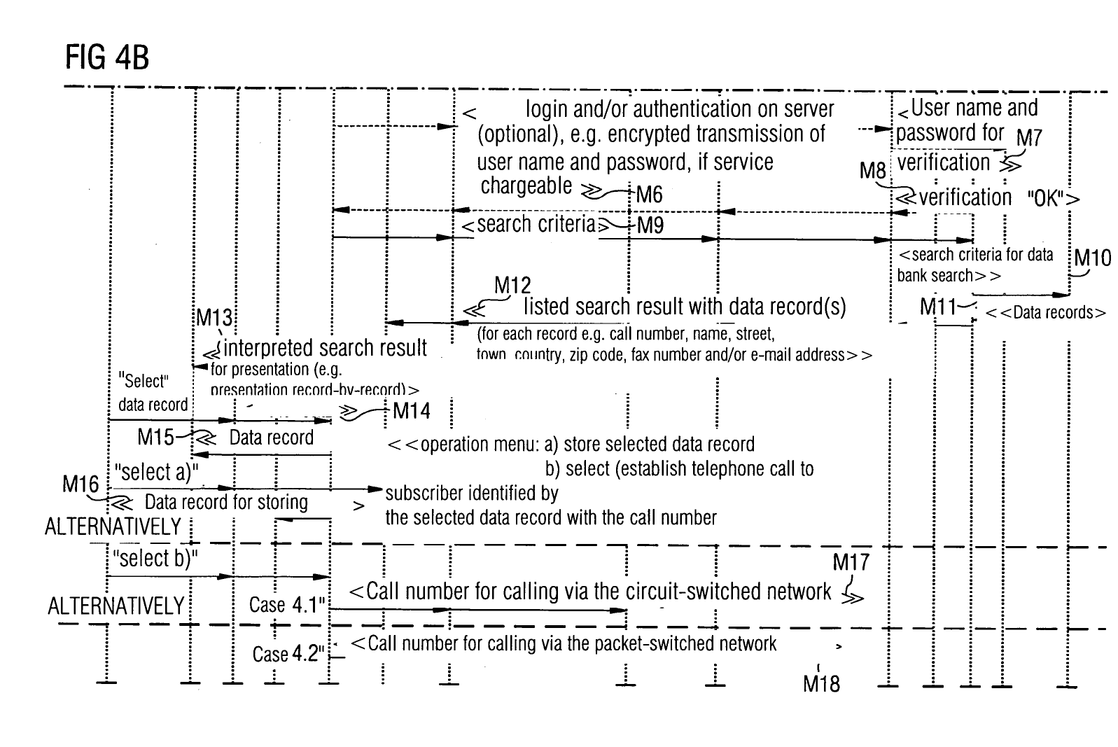

In contrast to the related art (FIG. 1), the search results are further used or further processed immediately. It is thus possible for example to directly dial a call number found or to store it locally in a telephone book memory of the telephone (cf. FIG. 4). In addition, an incoming telephone call with calling line identification presentation (call with CLIP) can be directly assigned a name and possibly an address if the transmitted call number is not contained in the local telephone book memory (cf. FIG. 3).

Before individual selected primary scenarios are discussed below—in relation to the description of FIGS. 3 and 4—in connection with the telephone book search on the basis of the explanations for FIG. 2, at this juncture a few secondary aspects of these scenarios or other scenarios for the telephone book search should already be pointed out, and their importance and implications for improved, more efficient searching (additional advantageous developments), will be examined briefly without going into details.

1. When searching in a telephone directory, if as a result of entering the character string “Meier” for a name as search criterion (complete character string entered), the search result contains a significantly larger number “n” than for example n=7 (individually specifiable limit value) data records (for example n=50, because such a number cannot be represented and output in a user-friendly manner on a telephone with a small telephone display in comparison with computer screens), then so-called ambiguity handling is preferably performed in the server supported by the dedicated protocol, during which, by transmitting further messages to the telephone, it is attempted at the server end to prompt the user to expand the search criterion, for example by offering more precise formulations of the search criterion used (for example transmitting first names from the plurality of data records), in order to limit or reduce the number of search results.

2. When searching in a telephone directory, if no data record can be found as a result of entering the character string “Ham” for a town and the character string “Barlow” for a name as search criterion (incomplete character string entered for town and complete character string entered for name) because the search criterion is ambiguous, ambiguity handling is again preferably performed in the server supported by the dedicated protocol, during which, by transmitting further messages to the telephone, it is attempted at the server end to prompt the user to optimize the search criterion, for example by offering more precise formulations of the character string used for the town (for example transmitting the names of towns stored in the data bank that begin with the character string entered, such as Hamburg, Hamm, Hammelbug, etc. for example), in order to obtain a search result.

3. When searching in a trade directory, if as a result of entering the character string “Bocholt” for a town, the character string “Schmidt, Schmitt, Schmid” for a name and a character string “doctor” for a trade as search criterion (complete character string entered in each case), the search result contains a significantly larger number “n” than for example n=5 (individually specifiable limit value) data records (for example n=25, because such a number cannot be represented and output in a user-friendly manner on a telephone with a small telephone display in comparison with computer screens), then again ambiguity handling is preferably performed in the server supported by the dedicated protocol, during which, by transmitting further messages to the telephone, it is attempted at the server end to prompt the user to expand the search criterion, for example by offering more precise formulations of the trade character string used (for example transmitting specific trades stored in the data bank under the category of “doctor”, such as general practitioner, dentist, ENT consultant, etc.), in order to limit or reduce the number of search results.

FIG. 3 shows a message sequence chart for illustrating an inverse telephone book search based on CLIP information. According to FIG. 3, the message sequence required for this takes place between a telephone user TBE who uses the telephone TE, the telephone TE, the circuit-switched network LNW, the packet-switched network PNW, the server SE and the telephone book data bank TBD.

The units or components included in the representation of the message sequence are:
(i) for the telephone TE with the cordless handset SLH, the mobile telephone MTF or the telephone handset THA, to which a user interface BSS and a central control unit ZSE with IP-termination and telephone book search functionality are assigned in each case, a display DPL, an earpiece HKA and a keypad TAS being assigned to the user interface BSS, and a telephone book memory TBS, a protocol interpreter PKI and a connection controller VST being assigned to the central control unit ZSE, as well as with the data terminal DEE with an assigned telephone/network interface TNS which are connected to one other in the manner indicated and which form a functional unit operating in the manner of a telephone; and
(ii) for the server SE with a server/network interface SNS and a control unit STE, to which a service billing module DFA and a user directory BVZ are assigned, which are connected to one other in the manner indicated and which form a functional unit operating in the manner of a server.

The message sequence illustrated begins with a call arriving at the telephone from either the circuit-switched network LNW (“case 3.1”) or from the packet-switched network PNW (“case 3.2”). In “case 3.1”, as a result of the activated CLIP functionality the circuit-switched network LNW transmits with a first message M1 the call number of the incoming call (subscriber) via the telephone/network interface TNS of the data terminal DEE to the central control unit ZSE of the cordless handset SLH, of the mobile telephone MTF or of the telephone handset THA, whereas in “case 3.2” again as a result of the activated CLIP functionality the packet-switched network PNW transmits with a second message M2 the call number of the incoming call (subscriber) via the telephone/network interface TNS to the central control unit ZSE.

If the central control unit ZSE of the telephone TE now wishes to perform an inverse telephone book search with the call number of the calling party received by CLIP and to access the server SE or the telephone book data bank TBD respectively for this purpose, it may for example be necessary for the telephone TE to log in on first accessing the server SE or the telephone book data bank TBD, or be authenticated in the case of a repeat access. For this purpose the central control unit ZSE of the telephone TE therefore sends with a third message M3 via the packet-switched network PNW a user name and a password, which the user has previously received by post or email from the operator of the server or of the telephone book data bank respectively and has on receipt entered via the keypad TAS, to the server SE, where the information is received by the server/network interface SNS. Unless the “inverse telephone book search” service is provided free by the service provider, in some circumstances it is expedient if the user name and the password are transmitted encrypted with the third message M3. The received user name and the password are transferred by the server/network interface SNS with a fourth message M4 to the control unit STE with the assigned user directory BVZ for verification. If it is also necessary (in the case of a chargeable service) to check whether the service user has paid the fees for the provision of the service, then this takes place in the service billing module DFA of the control unit STE. If the user name received and the password received are also contained in the user directory BVZ of the server SE, and any charges have been paid (positive verification), then a fifth message M5 with the content “Verification OK” is sent to the central control unit ZSE by the control unit STE with the assigned user directory BVZ and the service billing module DFA via the server/network interface SNS, the packet-switched network PNW and the telephone/network interface TNS of the telephone TE. Since the entire login/authentication process (messages M3-M5)—as already mentioned in the description of FIG. 2—is optional, this part of the message sequence is indicated by a dashed line in FIG. 3.

Following successful login or authentication, the call number of the calling party/caller is sent as search criterion by the central control unit ZSE with a sixth message M6 via the telephone/network interface TNS, the packet-switched network PNW to the server SE, where it is received by the server/network interface SNS and forwarded to the control unit STE. The search criterion/the call number is then transferred by the control unit STE with a seventh message M7 to the telephone book data bank TBD for the data bank search. As a result of this data bank search, with an eighth message M8 the control unit STE reads a data record from the telephone book data bank TBD, assembles a search result from the data record and with a ninth message M9 transmits the search result with the data record via the server/network interface SNS, the packet-switched network PNW and the telephone/network interface TNS of the telephone TE to the protocol interpreter PKI of the central control unit ZSE. The protocol interpreter PKI interprets the received search result with the aid of the tags MK used in accordance with the dedicated protocol PK during the structuring of the data in the data record (cf. FIG. 2) and is consequently able to understand the semantics of the search result. Following interpretation of the search result, preferably the call number, the name and/or the town from the data record of the search result are forwarded by the central control unit ZSE with a tenth message M10 to the user interface BSS, where they are output either on the display DPL or via the earpiece HKA, for example together with the ringing signal. With the output of the call number, the name and/or the town, the telephone user TEB is preferably also offered an operations menu with which he can either accept the incoming call [“option a)”] or store the data record of the search result in the telephone book memory TBS [“option b)”]. In the case of “option a)”, an “accept call” key is activated by the telephone user TEB via the keypad TAS and the call is then accepted by the connection controller VST. In the case of “option b)”, a key for storing the data record in the telephone book data memory TBS is activated by the telephone user TEB via the keypad TAS, with the result that the central control unit ZSE stores the data record in the telephone book data memory TBS in accordance with an eleventh message M11.

FIG. 4 shows a message sequence chart for illustrating an inverse/regular telephone book search based on a manual input. According to FIG. 4, the message sequence required for this again takes place between the telephone user TBE who uses the telephone TE, the telephone TE, the circuit-switched network LNW, the packet-switched network PNW, the server SE and the telephone book data bank TBD.

The units or components included in the representation of the message sequence are:
(i) for the telephone TE with the cordless handset SLH, the mobile telephone MTF or the telephone handset THA, to which the user interface BSS and the central control unit ZSE with the IP-termination and telephone book search functionality are again assigned in each case, the display DPL, the earpiece HKA and the keypad TAS again being assigned to the user interface BSS, and the telephone book memory TBS and the protocol interpreter PKI being assigned to the central control unit ZSE, as well as with the data terminal DEE with the assigned telephone/network interface TNS which again are connected to one other in the manner indicated and which form a functional unit operating in the manner of a telephone; and
(ii) for the server SE with the server/network interface SNS and the control unit STE, to which the service billing module DFA and the user directory BVZ are again assigned, which are again connected to one other in the manner indicated and which form a functional unit operating in the manner of a server.

The message sequence illustrated begins with the feature “telephone book search” being selected by the telephone user TEB on the keypad TAS. Following this, the telephone book search is started by the central control unit ZSE with a first message M1. In response to this, with a second message M2 the central control unit ZSE transmits a selection menu “inverse/regular search” to the display DPL of the user interface BSS. The telephone user TEB then makes a selection of “inverse/regular search” on the keypad TAS and the search type selected is notified to the central control unit ZSE with a third message M3. With a fourth message M4 the central control unit ZSE then transmits a search screen to the display DPL of the user interface BSS. Using the keypad TAS, the telephone user TEB enters search criteria in the search screen which are notified to the central control unit ZSE with a fifth message M5.

If the central control unit ZSE of the telephone TE now wishes to perform an inverse/regular telephone book search with the search criteria entered by the telephone user TEB and to access the server SE or the telephone book data bank TBD respectively for this purpose, it may for example again be necessary for the telephone TE to log in on first accessing the server SE or the telephone book data bank TBD, or be authenticated in the case of a repeat access. For this purpose the central control unit ZSE of the telephone TE therefore sends with a sixth message M6 via the packet-switched network PNW a user name and a password, which the user has previously received by post or email from the operator of the server or of the telephone book data bank respectively and has on receipt entered via the keypad TAS, to the server SE, where the information is received by the server/network interface SNS. Unless the “inverse/regular telephone book search” service is provided free by the service provider, in some circumstances it is expedient if the user name and the password are transmitted encrypted with the sixth message M6. The received user name and the password are transferred by the server/network interface SNS with a seventh message M7 to the control unit STE with the assigned user directory BVZ for verification. If it is also necessary (in the case of a chargeable service) to check whether the service user has paid the fees for the provision of the service, then this takes place in the service billing module DFA of the control unit STE. If the user name received and the password received are also contained in the user directory BVZ of the server SE, and any charges have been paid (positive verification), then an eighth message M8 with the content “Verification OK” is sent to the central control unit ZSE by the control unit STE with the assigned user directory BVZ and the service billing module DFA via the server/network interface SNS, the packet-switched network PNW and the telephone/network interface TNS of the telephone TE. Since the entire login/authentication process (messages M6-M8)—as already mentioned in the description of FIG. 2—is optional, this part of the message sequence is again indicated by a dashed line in FIG. 4.

Following successful login or authentication, the search criteria entered by the telephone user TEB according to messages M1 . . . M5 are sent by the central control unit ZSE with a ninth message M9 via the telephone/network interface TNS, the packet-switched network PNW to the server SE, where they are received by the server/network interface SNS and forwarded to the control unit STE. The search criteria are then transferred by the control unit STE with a tenth message M10 to the telephone book data bank TBD for the data bank search. As a result of this data bank search, with an eleventh message M11 the control unit STE reads at least one data record from the telephone book data bank TBD, assembles a search result from the data record(s) and with a twelfth message M12 transmits the search result with the data record(s), for example in the form of a list, via the server/network interface SNS, the packet-switched network PNW and the telephone/network interface TNS of the telephone TE to the protocol interpreter PKI of the central control unit ZSE. The protocol interpreter PKI interprets the received search result with the aid of the tags MK used in accordance with the dedicated protocol PK during the structuring of the data in the data record (cf. FIG. 2) and is consequently able to understand the semantics of the search result. Following interpretation of the search result, the data record(s) of the search result are forwarded by the central control unit ZSE with a thirteenth message M13 for presenting the record(s), which is preferably performed record-by-record, to the user interface BSS, where they are preferably output on the display DPL. It is however also possible for them to be output via the earpiece HKA.

The telephone user TEB then makes a data record selection using the keypad TAS and the data record selected is notified to the central control unit ZSE with a fourteenth message M14. With a fifteenth message M15 the central control unit ZSE then transmits an operation menu to the display DPL of the user interface BSS, which is output there, and with which the telephone user TEB is offered the option of either storing the selected data record [“option a)”] or performing a dialing operation with which a telephone connection is established to the subscriber identified by the selected data record with the corresponding call number [“option b)”]. In the case of “option a)”, a key for storing the data record in the telephone book data memory TBS is activated by the telephone user TEB via the keypad TAS, with the result that the central control unit ZSE stores the data record in the telephone book data memory TBS in accordance with a sixteenth message M16. In the case of “option b)”, a dialing key is activated by the telephone user TEB via the keypad TAS and the call number corresponding to the selected data record is then transmitted by the central control unit ZSE via the telephone/net-work interface TNS either with a seventeenth message M17 to the circuit-switched network LNW (“case 4.1”) or with an eighteenth message M18 to the packet-switched network PNW (“case 4.2”).

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-24. (canceled)

25. A method for use of telephone book data stored in a telephone book data bank of a server by a telephone, comprising:
connecting the telephone, via at least one of a packet-switched network and a circuit-switched network, to the server which has access to the telephone book data bank;
initiating access to the telephone book data bank to conduct a telephone book search targeted with respect to a search result, as a result of the telephone generating one of a first event that is a telephone call with calling line identification presentation and a second event using a telephone book search menu called up by a telephone user;
establishing, by the telephone upon starting the telephone book search, a logical connection to the server with access to the telephone book data bank;
transmitting at least one search criterion for the telephone book search to the server in accordance with a dedicated protocol, if necessary following at least one of login and authentication on at least one of the server and the telephone book data bank;
performing a search by the server in the telephone book data bank based on the at least one search criterion, if necessary following confirmation of the login or verification of the authentication;
transmitting the search result in accordance with the dedicated protocol to the telephone; and
directly using the search result for telephone-specific operations in the telephone which is able to understand semantics of the search result based on tags in the dedicated protocol.

26. The method as claimed in claim 25, wherein the search result contains a complete data record stored in the telephone book data bank for the at least one search criterion.

27. The method as claimed in claim 25, wherein when the telephone book search is initiated by the first event, the search result found for the at least one search criterion is at least one of output for the telephone user and stored in a local telephone book memory of the telephone.

28. The method as claimed in claim 27, wherein the search result found for the at least one search criterion is output at least partially, including at least a name of a subscriber found by the search and one of a call number and a town of the subscriber, in combination with a ringing signal.

29. The method as claimed in claim 25, wherein when the telephone book search is initiated by the second event,
if a single data record is found for the at least one search criterion, the single data record is at least one of output for the telephone user, stored in a local telephone book memory of the telephone and used immediately for an outgoing telephone call to a remote subscriber matching the single data record found; and
if a plurality of data records are found for the at least one search criterion, the data records are output for the telephone user and when a selected data record is determined from among the data records, the selected data record is either stored in the local telephone book memory of the telephone or is used immediately for the outgoing telephone call to the remote subscriber matching the selected data record.

30. The method as claimed in claim 29,
wherein the telephone book search is performed by searching names and addresses of telephone subscribers listed in the telephone book data bank for the at least one search criterion, and
wherein the search result contains a complete data record stored in the telephone book data bank matching the at least one search criterion.

31. The method as claimed in claim 29,
wherein the telephone book search is performed by searching telephone numbers of telephone subscribers listed in the telephone book data bank for the at least one search criterion, and
wherein the search result contains a complete data record stored in the telephone book data bank for the at least one search criterion.

32. The method as claimed in claim 31, wherein when a large volume of data, relative to display capability of the telephone, is included in the search result, the search result is transmitted sequentially.

33. The method as claimed in claim 25, wherein the at least one of login and authentication is performed by transmitting a user name and a password from the telephone to the server.

34. The method as claimed in claim 25, wherein the telephone is a Digital Enhanced Cordless Telecommunications mobile unit of a Digital Enhanced Cordless Telecommunications telephone having a Digital Enhanced Cordless Telecommunications base station connected to the at least one of the packet-switched network and the circuit-switched network.

35. The method as claimed in claim 25, wherein the telephone is a wireless local area network mobile unit of a wireless local area network telephone having a wireless local area network access point connected to the at least one of the packet-switched network and the circuit-switched network.

36. The method as claimed in claim 25, wherein the telephone is a telephone handset connected to a router that is connected via an ETHERNET cable to the at least one of the packet-switched network and the circuit-switched network.

37. A telephone for use of telephone book data stored in a telephone book data bank of a server, comprising:
a telephone/network interface, via which the telephone is physically connected via at least one of a packet-switched network and a circuit-switched network to the server which has access to the telephone book data bank;
a user interface; and
a central control unit, connected to said user interface and said telephone/network interface, having a local telephone book memory and a protocol interpreter and performing operations that trigger access to the telephone book data bank for a telephone book search targeted with respect to a search result, based on one of a first event in response to an incoming telephone call with calling line identification presentation and a second event in response to selection of an item in a telephone book search menu called up by a telephone user, by
establishing, upon starting the telephone book search, a logical connection to the server with access to the telephone book data bank,
transmitting at least one search criterion for the telephone book search to the server in accordance with a dedicated protocol, if necessary following at least one of login and authentication on at least one of the server and the telephone book data bank, that causes the server to perform a search in the telephone book data bank based on the at least one search criterion,
receiving the search result from the server as in accordance with the protocol via said telephone/network interface,
interpreting semantics of the search result using the protocol interpreter based on tags in the dedicated protocol, and
using the search result after the interpreting for telephone-specific operations.

38. The telephone as claimed in claim 37, wherein the search result contains a complete data record stored in the telephone book data bank that matches the at least one search criterion.

39. The telephone as claimed in claim 37, wherein said central control unit, when the first event occurs, at least one of outputs the search result to the telephone user via said user interface and stores the search result in the local telephone book memory.

40. The telephone as claimed in claim 39, wherein said central control unit causes said user interface to output the search result at least partially, including at least a name of a subscriber found by the telephone book search and one of a call number and a town of the subscriber, in combination with a ringing signal.

41. The telephone as claimed in claim 37, wherein when the second event occurs,
if a single data record is found for the at least one search criterion, said central control unit causes one of output of the single data record to the telephone user via said user interface, storage of the single data record in the local telephone book memory, and immediate initiation of an outgoing telephone call to a remote subscriber matching the single data record found, and
if a plurality of data records are found for the at least one search criterion, said central control unit causes said user interface to output the data records to the telephone user and receives an indication from the telephone user of a selected data record from among the data records, and either stores the selected data record in the local telephone book memory or uses immediately for an outgoing telephone call to a remote subscriber matching the selected data record.

42. The telephone as claimed in claim 41, wherein server performs the telephone book search by searching telephone numbers of telephone subscribers listed in the telephone book data bank, and
wherein said central control unit receives as the search result a complete data record stored in the telephone book data bank that matches the at least one search criterion.

43. The telephone as claimed in claim 41, wherein the telephone book search is performed by searching telephone numbers of telephone subscribers listed in the telephone book data bank for the at least one search criterion, and
wherein said central control unit receives as the search result a complete data record stored in the telephone book data bank for the at least one search criterion.

44. The telephone as claimed in claim 43, wherein said central control unit receives the search result sequentially from the server when the search result contains a large volume of data relative to capacity of said user interface.

45. The telephone as claimed in claim 37, wherein said central control unit transmits a user name and a password to the server for the at least one of login and authentication.

46. The telephone as claimed in claim 37, further comprising a Digital Enhanced Cordless Telecommunications mobile unit of a Digital Enhanced Cordless Telecommunications telephone having a Digital Enhanced Cordless Telecommunications base station connected to the at least one of the packet-switched network and the circuit-switched network.

47. The telephone as claimed in claim 37, further comprising a wireless local area network mobile unit of a wireless local area network telephone having a wireless local area network access point connected to the at least one of the packet-switched network and the circuit-switched network.

48. The telephone as claimed in claim 37, further comprising a telephone handset which is connected to a router that is connected via an ETHERNET cable to the at least one of the packet-switched network and the circuit-switched network.
